(19) United States
(12) Patent Application Publication
(10) Pub. No.: US 2026/0185812 A1
(43) Pub. Date: Jul. 2, 2026

(54) DEVICE ABNORMALITY SENSOR

(71) Applicant: SOFTPV INC., Gyeonggi-do (KR)

(72) Inventors: Hyeon Woo AHN, Gyeonggi-do (KR); Sung Gue LEE, Gyeonggi-do (KR)

(21) Appl. No.: 19/128,703

(22) PCT Filed: Oct. 24, 2023
(86) PCT No.: PCT/KR2023/016532

§ 371 Date: May 9, 2025

(30) Foreign Application Priority Data
Nov. 11, 2022 (KR) 10-2022-0150703

(51) Int. Cl. G01B 7/16

(52) U.S. Cl. CPC G01B 7/20

(57) ABSTRACT

Disclosed herein is a device abnormality sensor for detecting an abnormality of a device. In the device abnormality sensor according to the present disclosure, an elastic plate changes in response to a change in the device, and a detection unit recognizes an abnormality signal of a detection circuit printed on the elastic plate. Accordingly, the present disclosure enables rapid detection of subtle changes in the device.

### TECHNICAL FIELD

The present disclosure relates to a device abnormality sensor.

Particularly, the present disclosure relates to a device abnormality sensor capable of proactively detecting device abnormalities caused by deformation.

### BACKGROUND ART

Devices gradually deteriorate over time. Particularly, even if no external force is applied to a device, the device deteriorates over time, making continuous inspection and repair necessary.

However, it is extremely difficult to continuously inspect the device. Inspecting the device refers to positioning a worker or an apparatus adjacent to the device and checking for abnormalities of the device through visual inspection or other methods.

This requires the time and effort of the worker.

Furthermore, abnormalities that can be intuitively detected by the worker can be easily detected, whereas abnormalities for which it is difficult to intuitively detect, such as loosening of bolts and nuts, cannot be easily detected.

Various methods are used to overcome such problems. For example, a method of detecting loosening of bolts and nuts by generating sound in the device using an impact unit is used, but this method requires a high level of skill from the worker, has low accuracy, and involves difficulty in determining the location where the abnormality has occurred.

### DISCLOSURE

### Technical Problem

An embodiment of the present disclosure has been devised to solve the above problem, and an object of the present disclosure is to provide a device abnormality sensor capable of accurately detecting abnormalities of a device in real time.

### Technical Solution

A device abnormality sensor according to an embodiment may include an elastic plate that is connected to the device, is provided with a detection circuit printed on one surface thereof, and is configured to be deformable in response to deformation of the device, and a detection unit configured to detect an abnormality of the device by detecting a change in the detection circuit caused by deformation of the elastic plate.

The detection circuit may include a plurality of detection circuits positioned on the one surface of the elastic plate.

The detection circuits may include a first detection circuit, a second detection circuit, and a third detection circuit, and each of the detection circuits may have a different thickness.

At least one of the detection circuits may have a shape that is not at least a linear shape.

A substrate configured to apply current to the detection circuit may be connected to the detection circuit on one side of the elastic plate.

The detection unit may detect an abnormality signal of the detection circuit at a preset cycle.

### Advantageous Effects

An embodiment of the present disclosure allows an elastic plate to contract and expand in response to movement of a device, thereby detecting changes in the intensity of current in a detection circuit printed on the elastic plate, thus enabling accurate real-time detection of abnormalities in the device.

### BRIEF DESCRIPTION OF DRAWINGS

FIG. 1 is an operation diagram of a device abnormality sensor according to an embodiment of the present disclosure.

FIG. 2 illustrates a device abnormality detection system according to an embodiment of the present disclosure.

FIG. 3 is an enlarged view of an elastic plate of the device abnormality detection system according to an embodiment of the present disclosure.

FIG. 4 illustrates a device abnormality sensor according to another embodiment of the present disclosure.

FIG. 5 is an enlarged view of an elastic plate of a device abnormality sensor according to another embodiment of the present disclosure.

FIG. 6 is an exploded view of a detection unit of the device abnormality sensor according to an embodiment of the present disclosure.

### BEST MODE

Hereinbelow, an embodiment of the present disclosure will be described in detail with reference to exemplary drawings. However, this is not intended to limit the scope of the present disclosure.

In adding reference numerals to elements in each drawing, it should be noted that the same components are designated by the same reference numerals, if possible, although they are shown in different drawings. Furthermore, in the following description, a detailed explanation of known related configuration or function may be omitted to avoid unnecessarily obscuring the subject matter of the present disclosure.

Also, the size, shape, etc. of the components shown in the drawings may be exaggerated for clarity and convenience of description. Furthermore, terms specifically defined in consideration of the configuration and operation of the present disclosure are only for describing the embodiments of the present disclosure and do not limit the scope of the present disclosure.

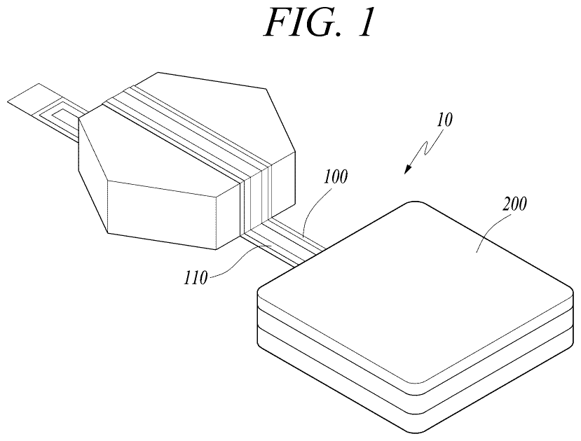

FIG. 1 is an operation diagram of a device abnormality sensor according to an embodiment of the present disclosure.

The device abnormality sensor 10 according to an embodiment of the present disclosure may include an elastic plate 100 and a detection unit 200.

The elastic plate 100 may have a detection circuit 110 printed on one surface thereof, and may be formed of a flexible material. The elastic plate 100 is connected to a device. The elastic plate 100 connected to the device may be changed in shape in response to movement of the device.

For example, as shown in FIG. 1, in the case where a bolt is loosened, the elastic plate 100 may be elongated in response to the movement of the bolt. As the elastic plate 100 is deformed, a spacing or thickness of the detection circuit 110 may be changed. Accordingly, the detection circuit 110 has a resistance value different from an existing resistance value, and therefore, a current value flowing through the detection circuit 110 also becomes different from a current value that has previously flowed.

The detection unit 200 may detect a change of the detection circuit 110, thereby detecting an abnormality of the device. For example, the detection unit 200 may detect a change in the current value, thereby detecting that an abnormality has occurred in the device. As such, the present disclosure may accurately determine the abnormality of the device in real time.

Furthermore, the detection unit 200 may be positioned, for example, on one side of the elastic plate 100, perform solar power generation to generate energy, and apply current to the detection circuit 110.

In addition, the detection unit 200 may apply current to the detection circuit 110 at a preset cycle to detect a change in the detection circuit 110. That is, the detection unit 200 may apply current at the preset cycle and determine a change in the current value of the detection circuit 110 at the preset cycle.

Accordingly, the present disclosure may efficiently utilize energy.

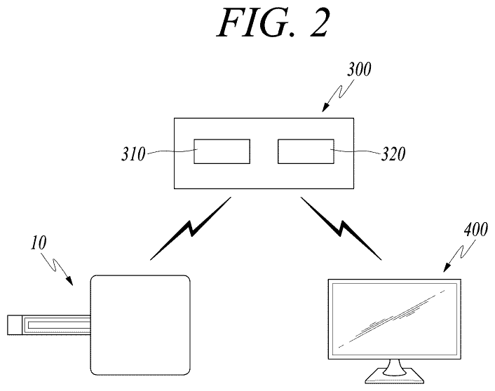

FIG. 2 illustrates a device abnormality detection system according to an embodiment of the present disclosure.

The device abnormality detection system according to an embodiment of the present disclosure may include the above-described device abnormality sensor 10, a short-range communication unit 300, and a monitoring unit 400.

The detection unit 200 may transmit detected information to the monitoring unit 400 through the communication unit 300.

Here, the communication unit 300 may include a short-range communication component 310 configured to perform short-range communication, and a server system component 320 configured to transceive information received through the short-range communication component 310. In other words, the detection unit 200 may transmit information about whether an abnormality of the device has occurred to the short-range communication component 310, and the short-range communication component 310 may transmit the received information to the server system component 320.

The monitoring unit 400 is connected to the server system component 320, and may check the information transmitted to the server system component 320 in real time, and determine an abnormality of the device in real time.

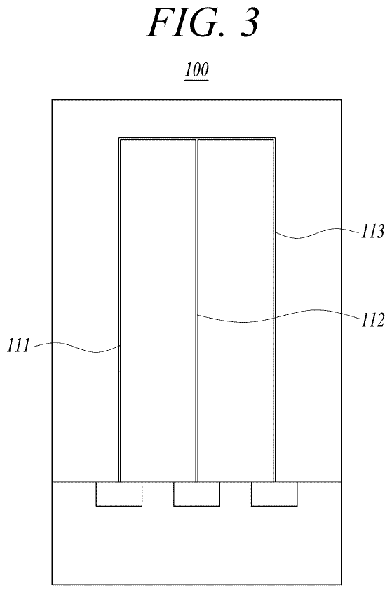

FIG. 3 is an enlarged view of an elastic plate of the device abnormality detection system according to an embodiment of the present disclosure.

According to an embodiment of the present disclosure, a plurality of detection circuits 110 may be printed on the elastic plate 100.

For example, the detection circuits 110 may include a first detection circuit 111, a second detection circuit 112, and a third detection circuit 113.

The first detection circuit 111, the second detection circuit 112, and the third detection circuit 113 may be provided on the elastic plate 100 at positions spaced apart from each other. Specifically, the second detection circuit 112 may be positioned between the first detection circuit 111 and the third detection circuit 113. As such, the present disclosure may detect even subtle deformation of the device, since the multiple detection circuits 110 are located at different positions on the elastic plate 100.

Here, each of the detection circuits 110 may be formed using Ag/epoxy paste as a material.

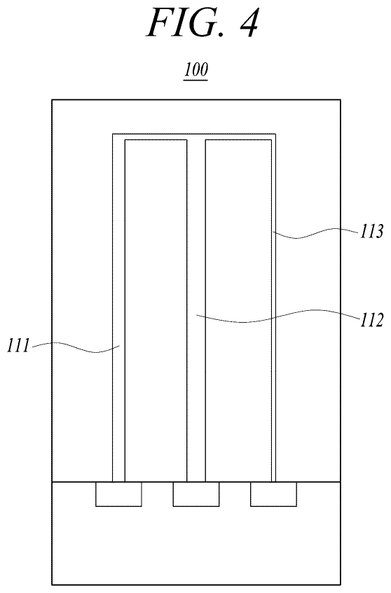

FIG. 4 illustrates a device abnormality sensor according to another embodiment of the present disclosure.

In the device abnormality sensor 10 according to an embodiment of the present disclosure, a first detection circuit 111, a second detection circuit 112, and a third detection circuit 113 may have different thicknesses. Specifically, the first detection circuit 111, the second detection circuit 112, and the third detection circuit 113 may differ in thickness, such that the third detection circuit 113 may be thicker than the first detection circuit 111, and the second detection circuit 112 may be thicker than each of the first detection circuit 111 and the third detection circuit 113.

Accordingly, in an embodiment according to the present disclosure, a change in the current value of the detection circuit 110 caused by an abnormality of the device may be further increased. Therefore, in the case where an elastic portion according to the present disclosure is deformed due to a subtle change in the device, a resistance value thereof may significantly change, thus causing an extremely large change in the current value.

Accordingly, the present disclosure according an embodiment may more accurately check the abnormality of the device.

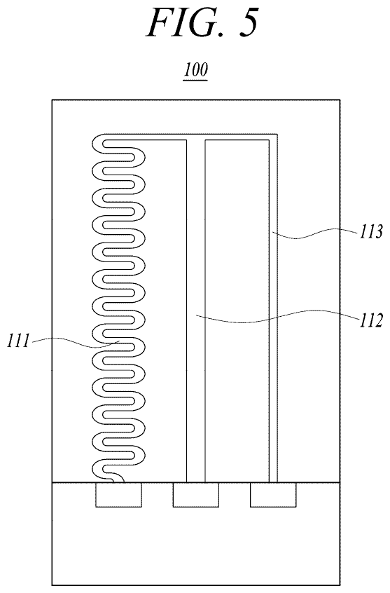

FIG. 5 is an enlarged view of an elastic plate of a device abnormality sensor according to another embodiment of the present disclosure.

In an embodiment, the present disclosure may include a detection circuit 110 printed in a shape other than a linear shape.

For example, as illustrated in FIG. 5, the elastic plate 100 according to the present disclosure may be provided with a first detection circuit 111 formed in a wavy shape.

As such, the first detection circuit 111 may be formed in a wavy shape, and the second detection circuit 112 and the third detection circuit 113 may each be formed in a linear shape.

Accordingly, in the present disclosure, the wavy first detection circuit 111, which has a high resistance value, may undergo a significant change in resistance value even in response to a subtle change in the device, thereby enabling detection of an abnormality of the device.

Here, the first detection circuit 111 and the second detection circuit 112 may have similar widths. For example, the first detection circuit 111 and the second detection circuit 112 may be formed with a width of 2 mm. However, the third detection circuit 113 positioned at an outer side on the elastic plate 100 may have a smaller width than each of the first detection circuit 111 and the second detection circuit 112. For example, the width of the third detection circuit 113 may be 1 mm. Accordingly, in the present disclosure, the second detection circuit 112 may maintain a stable resistance value, whereas the first detection circuit 111 and the third detection circuit 113 may each undergo a significant change in resistance value in response to deformation of the device.

As such, the present disclosure may easily detect even subtle changes in the device due to a specific shape of the detection circuit 110. Although only the device abnormality detection circuits have been described in FIGS. 3 to 5, it is apparent that all of the aforementioned detection circuits are implemented in the system described in FIG. 2.

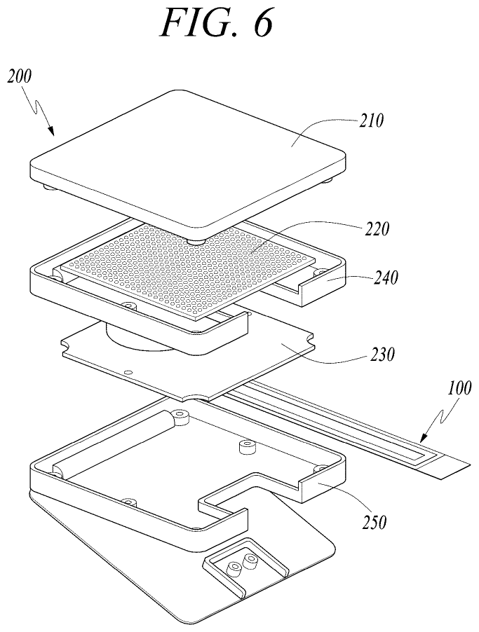

FIG. 6 is an exploded view of the detection unit of the device abnormality sensor according to an embodiment of the present disclosure.

The detection unit 200 according to an embodiment of the present disclosure may include an upper casing 210, a power generation component 220, a substrate 230, an intermediate casing 240, and a lower casing 250.

The upper casing 210 may be positioned at an upper side of the detection unit 200. The upper casing 210 may be formed in a shape with an open lower side. The upper casing 210 may be formed to be transparent. Accordingly, sunlight may be transmitted through the upper casing 210. A fastening part formed downward may be provided near each corner of the upper casing 210.

The power generation component 220 may be disposed in a shape enclosed by the upper casing 210. The power generation component 220 may have cells disposed on one surface thereof to generate energy when receiving sunlight. Here, the power generation component 220 may be formed smaller than the upper casing 210.

The substrate 230 may be positioned below the power generation component 220 and may be connected to the power generation component 220. Furthermore, the substrate 230 may be connected to the elastic plate 100. Therefore, the substrate 230 may apply current to the detection circuit 110 of the elastic plate 100 by using energy generated by the power generation component 220. Here, a fastening notch may be formed in each corner of the substrate 230 (at a position corresponding to a portion where the associated fastening part of the upper casing 210 is formed).

The intermediate casing 240 may be positioned below the upper casing 210, and may support the power generation component 220 at an upper side thereof, with the substrate 230 positioned at a lower side thereof. A fastening part into which the corresponding fastening part of the upper casing 210 is inserted and fitted may be positioned near each corner of the intermediate casing 240. Therefore, the fastening parts of the upper casing 210 may be coupled and secured to the corresponding fastening parts of the intermediate casing 240. Hence, the power generation component 220 may be secured between the upper casing 210 and the intermediate casing 240.

The lower casing 250 may be positioned below the intermediate casing 240. Fastening parts may be formed on the lower casing 250 at positions corresponding to the respective fastening parts of the intermediate casing 240. Therefore, the lower casing 250 may be positioned below the intermediate casing 240 and may be coupled to the intermediate casing 240 through the respective fastening parts. Accordingly, the substrate 230 disposed below the intermediate case 240 may be secured between the intermediate casing 240 and the lower casing 250.

Here, the lower casing 250 may have a recess to define a space in which the elastic plate 100 connected to the substrate 230 can be positioned so as to be exposed to the outside. More specifically, a peripheral wall extending upward may be formed along a periphery of the lower casing 250, and a height of a portion of the peripheral wall where the elastic plate 100 is positioned may be lower than a height of other portions of the peripheral wall. Therefore, the elastic plate 100 may be positioned so as to be exposed to the outside.

Although the specific embodiments of the present disclosure have been illustrated and described, it will be apparent to those skilled in the art that various modifications, additions and substitutions are possible, without departing from the scope and spirit of the present disclosure as set forth in the following claims.

### DESCRIPTION OF THE REFERENCE NUMERALS

10: Device abnormality sensor
100: Elastic plate
110: Detection circuit
111: First detection circuit
112: Second detection circuit
113: Third detection circuit
200: Detection unit
210: Upper casing
220: Power generation component
230: Substrate
240: Intermediate casing
250: Lower casing
300: Communication unit
310: Short-range communication component
320: Server system component
400: Monitoring unit

What is claimed is:

1. A device abnormality sensor for detecting an abnormality of a device, comprising:
an elastic plate connected to the device, and provided with a detection circuit printed on one surface thereof, the elastic plate being configured to be deformable in response to deformation of the device; and
a detection unit configured to detect an abnormality of the device by detecting a change in the detection circuit caused by deformation of the elastic plate.

2. The device abnormality sensor of claim 1, wherein the detection circuit comprises a plurality of detection circuits positioned on the one surface of the elastic plate.

3. The device abnormality sensor of claim 2, wherein the detection circuits comprise a first detection circuit, a second detection circuit, and a third detection circuit, and
wherein each of the detection circuits has a different thickness.

4. The device abnormality sensor of claim 3, wherein at least one of the detection circuits has a shape that is not at least a linear shape.

5. The device abnormality sensor of claim 1, wherein a substrate configured to apply current to the detection circuit is connected to the detection circuit on one side of the elastic plate.

6. The device abnormality sensor of claim 1, wherein the detection unit detects an abnormality signal of the detection circuit at a preset cycle.
